(19) United States
(12) Patent Application Publication
(10) Pub. No.: US 2021/0118064 A1
(43) Pub. Date: Apr. 22, 2021

(54) METHODS FOR ENHANCING SAFETY BY RISK MANAGEMENT SYSTEMS

(71) Applicant: Adwait TARE, Skillman, NJ (US)

(72) Inventor: Adwait TARE, Skillman, NJ (US)

(21) Appl. No.: 16/782,305

(22) Filed: Feb. 5, 2020

Related U.S. Application Data
(60) Provisional application No. 62/924,390, filed on Oct. 22, 2019.

(51) Int. Cl. G06Q 50/00; G06F 16/954; G06Q 40/02; G06Q 20/08; G06Q 30/02; G06Q 20/32

(52) U.S. Cl. CPC G06Q 50/01; G06F 16/954; G06Q 40/02; H04L 67/02; G06Q 30/0282; G06Q 20/3223; G06Q 30/0208; G06Q 20/0855

(57) ABSTRACT

The preferred embodiment according to this invention is a method of organizing human activity on the internet towards minimizing risk, said method comprising: providing an internet system comprising a requester portal through which a human requester may pose a question framing an issue for resolution/advice to the plurality of human resolvers; a resolver portal through which a human resolver may provide advice regarding the issue through internet communication in return for compensation; obtaining a payment from each requester; using proprietary rating system to determine compensation for resolver; using only a portion of said payment to compensate said resolver for the advice; wherein a plurality of said requesters and a plurality of said resolvers are participating in said internet system in a comprehensive approach to minimize said risk.

This application claims priority to U.S. Provisional Application Ser. No. 62/924,390, filed on Oct. 22, 2019, which is hereby incorporated by reference in its entirety.

### FIELD OF INVENTION

The present invention is related to an internet system and a method of using the internet system for risk management and mitigation. More specifically, the present invention discloses a new and useful internet system which enables monetizing the exchange of risk related information between users of said system.

### BACKGROUND OF THE INVENTION

Today's world of unprecedented technological and business advancement is giving rise of disruptive problems and risks in every technological area. If a proper mechanism to tackle these problems and risks in a timely manner is not in place, individuals, communities and businesses may be impacted in a disruptive manner leading to monitory losses, operational inefficiencies or failures, loss of reputation and/or public disturbances. Therefore, appropriate problem and risk management is imperative to keep individuals, communities, and businesses safe and functional.

It would be extremely useful for a user to seek custom tailored risk mitigation and management advice that is specific to his area of business or technology from an expert using internet as the mode of communication. Such a means would guarantee high quality customized advice to the user with a fast turnaround time avoiding the expense of direct meetings or hiring of the expert as an employee or consultant. Further, in the present day of fast changing technology and business methods, it becomes important for a user to obtain the specialized advice in shortest possible time with the freedom to select an expert of his choice who may be a person known to the user or unknown to the user but with proven credentials in the field where the user is seeking advice. Thus, there is a need to develop an internet system which can connect an individual or a business to an expert who can provide advice.

US Publication Serial Number US 2003/0002445 discloses a system and method for providing a virtual advisor. The systems or methods therein are related to internet-based or non-internet based computer network, claims to determine a solution for user's query using pre-defined rules, case-based reasoning or predefined rules and case-based reasoning, and providing the user with electronic access to live expert to receive advise on the user's query when a solution to the user's query cannot be determined using case-based reasoning. This method is focused on helping users with personal care products.

Australian publication Serial No. 2017100685 discloses a mobile phone, tablet and web application that matches and connects a user with a specialist superannuation financial adviser through a data collection and automatic investor risk profile assessment to provide simple, online user experience to receive current and ongoing superannuation financial advice, superannuation investment portfolio management and online access to detailed portfolio and account information. This method is focused on helping users with financial investment portfolio and insurance policies.

However, neither of the above disclosures provides for an internet system where a user can evaluate and/or choose an advisor from whom he could request advice. Similarly, none of these systems provide a way of monetizing the exchange of information in a continuous manner which becomes an important incentive in bring qualified experts into said system.

The present invention provides an internet system for individuals, communities or businesses facing problems or risks to seek advice from a chosen expert and monetizing the exchange with such an expert, facilitating high quality solutions and risk treatment options.

### SUMMARY OF INVENTION

The scope of the invention includes a method related to an internet system comprising: a requester portal through which a human requester may pose a question framing an issue for resolution and/or advice to the plurality of human resolvers; a resolver portal through which a human resolver may provide advice regarding the issue through internet communication in return for a compensation; means for collecting payment from said requesters; means for compensating said resolvers; wherein only a portion of said payment is used to compensate said resolver, and wherein a plurality of said requesters and a plurality of said resolvers are participating in said internet system in a comprehensive approach to minimize said risk.

### DESCRIPTION OF THE FIGURES

FIG. 1 shows the workflow of the issue resolution and/or risk management method wherein the requesters are individuals, businesses or communities.

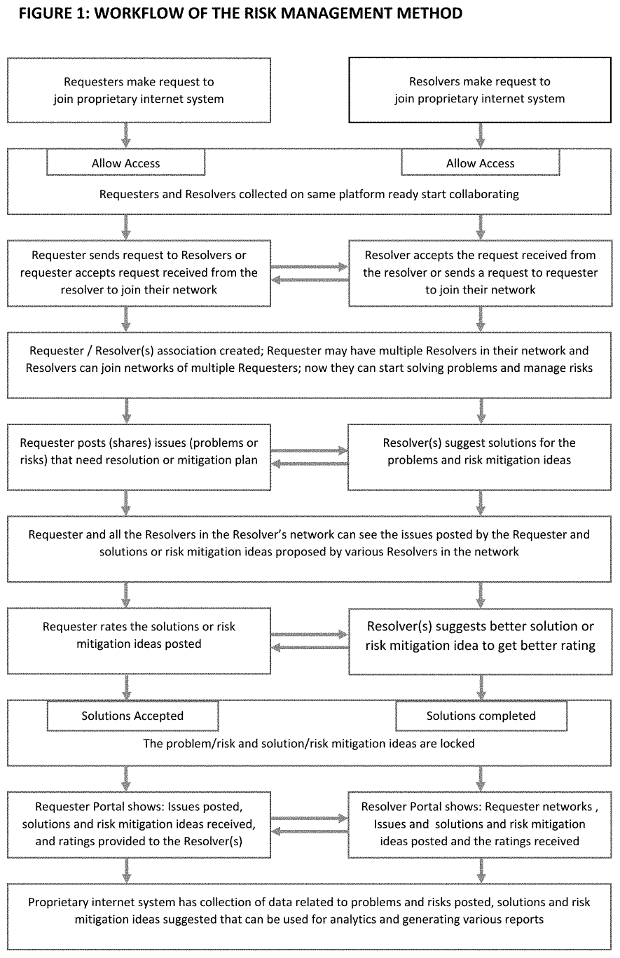

FIG. 2 shows the workflow involving data analytics and reporting

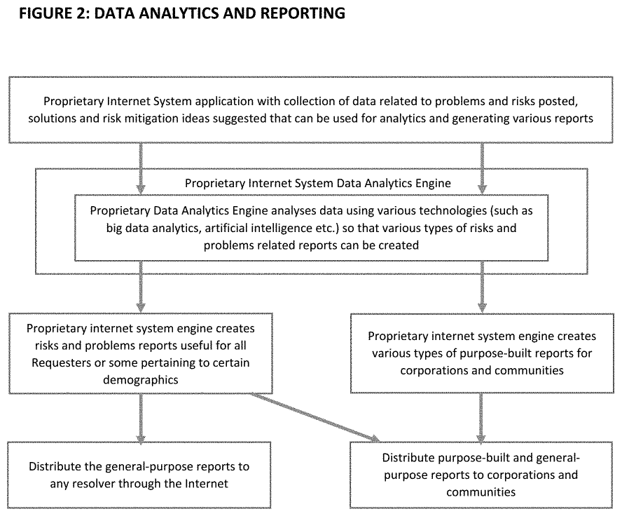

FIG. 3 shows the workflow involving automated data collection and proactive reporting

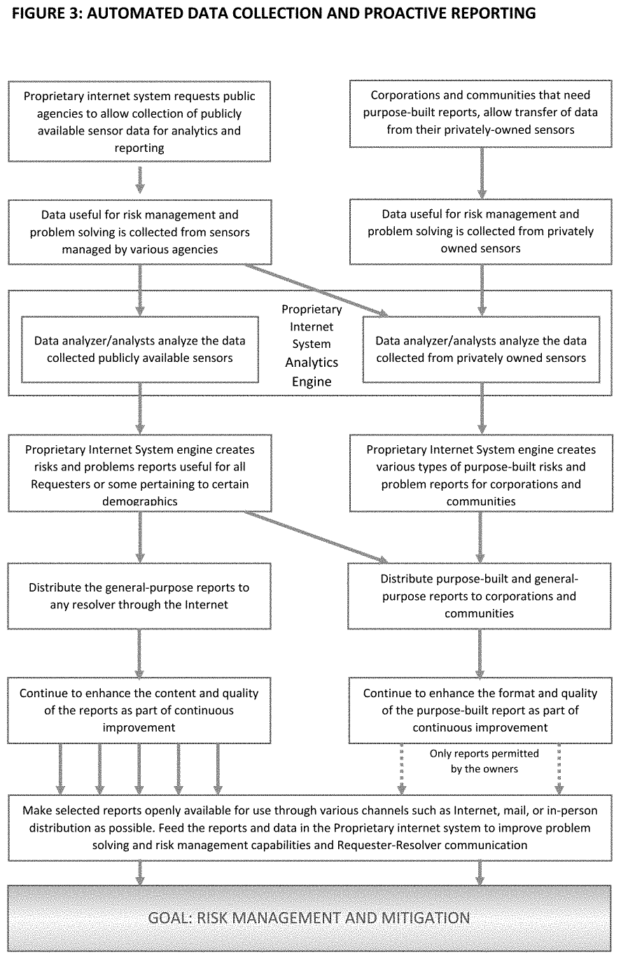

### DESCRIPTION OF THE PREFERRED EMBODIMENT

The invention is defined with reference to the appended claims. With respect to the claims, the glossary that follows provides the relevant definitions:

The issue according to the invention is a problem or a risk encountered by a requester.

The advice according to the invention is a solution, a resolution, a suggestion or a risk treatment option provided by a resolver in response to an issue posed by the requester towards achieving problem management or risk management and mitigation.

The requester according to the invention is a user of the internet system who may be an individual user, a community user or business user seeking advice to address the issues.

The resolver according to the invention is a user of the internet system who may be an individual user, a community user or business user willing to provide advice to address the issue.

The individual user according to the invention is a person who is seeking to solve or provide advice on issues. The community user according to the invention is one or more people working for a common purpose or a common organization that is for-profit or non-profit seeking to provide advice on issues. The business user according to the invention is one or more people working for a small, medium or large corporation seeking to solve or provide advice on issues.

The internet system according to the invention is a proprietary platform which comprises a web or mobile device compatible application. The web or mobile device compatible application is a special application designed to provide access to the internet system.

The internet system according to the invention may be accessed from a computer or a mobile device. A mobile device according this invention could be a smart phone or tablet.

The internet system according to the invention provides a means to connect requesters and resolvers. The internet system according to this invention provides a means to allow communication between the requesters and resolvers in order to resolve issues. The internet system according to the invention is a combination of a server side and user side applications. The internet system according to the invention comprises of a data repository, a means to connect the requesters and the resolvers on a web portal which allows the exchange of issues, advice, and communications thereof among other things. The data repository comprises of information related to requester profile, resolver profile, resolution networks, issues, advice and other information exchanged between the requester and the resolver or included by said system for facilitating the exchange. The data repository further comprises of archived or historical issues and advice.

The owner according to the invention is one or more people or a business entity operating the running of the internet system on their server incurring business costs and monetizing the exchange of issues and advice related information or communication by the users on the system.

The internet communication according to the invention is any exchange of information on the internet system, using internet, between users, including information exchanged in relation to issues and advice.

The compensation according to the invention may be a monetary or non-monetary compensation. Monetary compensation could be cash or credits, which credits may be used to buy gifts, gift cards, cash or other benefits. Non-monetary compensation could be points or system credits that may be used to buy gifts, gift cards, cash or other benefits. Revenue for the monetary benefit may be generated from the cash or credits paid by the requester when posting an issue to the resolver. Revenue for the monetary benefit may be generated from the advertisements that may be displayed on the internet system. Revenue for the non-monetary benefit may be generated from the advertisements that may be displayed on the internet system.

The sensor according to the invention is a monitoring device that gathers data regarding the state of the system or the environment that it is monitoring and of the monitoring devices itself. This monitoring data is collected in a database and is called sensor data. This sensor data can be used for getting better understanding of the system or the environment.

The requester portal according to the invention is the interface available to the requester upon requesting and qualifying for the service of the internet system. The requester portal in this embodiment is a collection of webpages which comprises of the profile of the requester, profiles of resolvers participating in their resolution networks, multiple resolution networks with connectivity to multiple resolvers, repository of the current as well as archived issues and the advice, method to archive issues and advice, method to re-open archived issues and advice, method to manage resolution networks and method to manage resolver participation and their membership to the resolution networks.

The requester portal provides a means for the requester to connect to a resolver. Typically, this is done by considering his or her expertise and experience. The requester portal provides means to describe the issues and discuss possible options to address the issues provided as advice by the resolvers. The requester portal provides means to request advice on the described issues from the resolver network(s), which network may be an internal network or an external network. An internal network comprises of expert users belonging to the same community or business as the requester. The external network comprises of expert users who are outside experts not related to the requester. The requester portal provides means to seek advice from one or more resolvers in a network or one or more resolution networks. The requester portal provides a means for a requester to post an issue anonymously, if he wants to keep his identity confidential.

The requester portal comprises a means for collecting payment from requester, which payment is the amount paid when the requester asks a question or posts an issue. Preferably, the payment in the form of cash is collected from requester users belonging to communities and businesses. Payment collected may be used for paying resolvers as well as owners of the said internet system. Individual requester users are not charged payment. Revenue to pay resolvers who help individual requester users may be derived from advertisements on the web portal.

The requester portal allows the requesters to receive advice from one or more resolvers in his resolution network in exchange for cash or credit, at which time the advice has to be selected and rated. The payment collected is used to pay the resolver based on a proprietary rating system as discussed below. The internet system provides a means to return a portion of the amount back to the requester every time the received advice is selected and rated.

The requester portal provides means to see all the previous posted issues, received advice and assigned rating. The requester portal provides means to post the issues and advice or solutions, which advice may be kept private or be published. The portal also provides means to publish the posted issues, advice or solutions in the public database of the internet system which is available to all the users of the internet system for their benefit and education.

The requester portal allows selection of issue category or subcategory of various topics from an array of categories and sub-categories such that the requester can select the right topic and then include additional details of the issue to which the resolver can provide a detailed response. For example, a requester may categorize his issue under one or more categories from a selection of categories provides in the portal. From any of the selected category, the requester may further select one of more subcategories from a selection of subcategories provided in the portal. A requester is provided with the option to provide additional details of the issue. This type of granular characterization of issue to a specific category and subcategory helps organization of the issue and aids in aligning a right resolver to said issue based on their expertise.

The resolver portal according to the invention is the interface available to the resolver upon requesting and qualifying for the service of the internet system. The resolver portal provides a means to the resolver to accept (or not accept) the invitation to join a requester's resolution network. The resolver portal provides a means for the resolver to send request to the requester, to be accepted as a resolver. The resolver portal provides means to the resolver to be part of one or more resolution networks. The resolver portal allows the resolver to see all his connected or participating requester networks. The resolver portal allows the resolver to research, formulate and provide advice to the requester according to his convenience, at any time. The resolver portal provides means to ask further questions or seek more information from the requester, when necessary. The resolver portal allows the resolver to see his previously answered issues and advice. The resolver portal provides a means to provide a detailed response to an issue as required by the requester. The resolver portal provides means to see previously accrued cash, or credits which may be used to buy cash, gift cards or gifts. The resolver portal provides a means for a resolver to provide advice anonymously, in case he wants to keep his identity confidential.

The resolution network according to the invention is a network created by requester comprising a selection of resolvers. Alternatively, the resolution network may be created by the owner of the internet system, wherein the network comprises of a selection of the requesters, resolvers and categories of the issues. Typically, resolvers are invited after considering their expertise and experience on the issues relevant to the requester for the purpose of exchanging information regarding issues and advice. More specifically, a requester may connect with different resolvers creating different resolution networks. A single requester may create multiple resolution networks, wherein said networks may be an internal network or an external network. An internal network comprises of expert users belonging to the same community or organization as the requester whereas the external network comprises of expert users who are outside experts not related to the requester or his organization.

The internet system according to this invention calculates the compensation to the resolver based on a proprietary rating system, wherein the proprietary rating system is constructed by the input from the requesters for the quality of advice that was provided to them by the resolvers, for example, better advice gets awarded with higher rating and the resolvers who have provided the advice that was rated higher by the requester get paid higher. The internet system provides compensation to the resolvers in the form of monetary benefit or non-monetary benefits. Monetary benefits comprise of cash or credits. The credits received by the resolvers may be used to buy gifts, gift cards, cash or other benefits on the portal. The compensation may be in the form of non-monetary benefit such as points or system credits that may be used to buy gifts, gift cards, cash or other benefits.

The internet system provides a means for the owners of the system to derive the money, which money is the difference between the money paid by requesters and the money in the form of cash, credits, points or system credits distributed to the resolvers and requesters.

The internet system according to the invention will continuously collect the data exchanged in the above disclosed manner and as allowed by the users, which then will be used to perform trend analysis to be made available to all users.

The internet system according to the invention allows hierarchical categorization and sub-categorization of issues at multiple levels in order to identify unique issue types in which the requester can post detailed requests and resolvers can post detailed responses.

In a preferred embodiment of this invention, the method of organizing human activity on the internet towards minimizing impact of issues and risks comprises of said method providing an internet system comprising a requester portal through which a human requester may pose a question framing an issue for advice to the plurality of human resolvers; a resolver portal through which a human resolver may provide advice regarding the issue through internet communication in return for compensation; obtaining a payment from each requester; using only a portion of said payment to pay said resolver for the advice; wherein a plurality of said requesters and a plurality of said resolvers are participating in said internet system in a comprehensive approach to minimize said issues or risks.

In a preferred embodiment of this invention, the method of organizing human activity on the internet towards minimizing impact of issues and risks comprises of said method providing an internet system comprising a requester portal through which a human requester may pose a question framing an issue for advice to the plurality of human resolvers anonymously; a resolver portal through which a human resolver may provide advice regarding the issue through internet communication, with the option of being anonymous, in return for a compensation.

In an embodiment, individual users will not be required to pay money to request advice. The requester portal in this embodiment provides means for displaying advertisements on products and services relevant to the issues and risks that are of interest to the user. The portal in this embodiment provides means for awarding credits to the external resolvers using the revenue generated from said advertisements.

In a modified and improved form of the above embodiment, the internet system according to this invention upon collecting a large enough data pool, after a period of time, will generate actionable intelligence and useful trend reports that may be sold by the owners to interested individuals, communities or businesses at a cost.

In a further modified and improved form of the above embodiment, the internet system by the means of one or more connected and unconnected sensors, will allow collection of data from individual users, communities and businesses. The system provides means for the resolvers to use such data from the sensors enabling a more precise, real-time analysis of the issue and tailor their advice to be more useful and effective.

In another embodiment, the system provides a direct means to collect data from the sensors through a direct computer network connection, a data collection software and a recording database, wherein said direct data collection enables better and real-time solutions to issues. The system provides means to generate trend reports and actionable intelligence to be sold by the owners to interested individuals, communities or businesses at a cost.

The preferred embodiment according to this invention is a method of organizing human activity on the internet towards minimizing risk or resolving issues, said method comprising: providing an internet system comprising a requester portal through which a human requester may pose a question framing an issue for resolution or advice to the plurality of human resolvers; a resolver portal through which a human resolver may provide advice regarding the issue through internet communication in return for monetary compensation; obtaining a payment from each requester; using only a portion of said payment to pay said resolver for the advice; wherein a plurality of said requesters and a plurality of said resolvers are participating in said internet system in a comprehensive approach to minimize said risk or issue resolution.

The preferred embodiment according to this invention is an Internet system comprising: a requester portal through which a human requester may pose a question framing an issue for resolution/advice to the plurality of human resolvers; a resolver portal through which a human resolver may provide advice regarding the issue through internet communication in return for compensation; means for collecting payment from said requesters; means for paying said resolvers; wherein only a portion of said payment is used to pay said resolver, and wherein a plurality of said requesters and a plurality of said resolvers are participating in said internet system in a comprehensive approach to minimize said risk.

While the invention has been described above with reference to specific embodiments thereof, it is apparent that many changes, modifications, and variations can be made without departing from the inventive concept disclosed herein, and such description is not intended as limitations on the scope thereof. Accordingly, it is intended to embrace all such changes, modifications, and variations that fall within the spirit and broad scope of the appended claims.

What is claimed is:

1. A method of organizing human activity on the internet towards minimizing risk, said method comprising:
a) providing an internet system comprising
i) a requester portal through which a human requester may pose a question framing an issue for advice to the plurality of human resolvers;
ii) a resolver portal through which a human resolver may provide advice regarding the issue through internet communication in return for a compensation;
b) obtaining a payment from each requester;
c) using only a portion of said payment to compensate said resolver for the advice;
wherein a plurality of said requesters and a plurality of said resolvers are participating in said internet system in a comprehensive approach to minimize said risk.

2. An Internet system comprising
a) a requester portal through which a human requester may pose a question framing an issue for advice to the plurality of human resolvers;
b) a resolver portal through which a human resolver may provide advice regarding the issue through internet communication in return for a compensation;
c) means for collecting payment from said requesters;
d) means for compensating said resolvers;
wherein only a portion of said payment is used to pay said resolver, and wherein a plurality of said requesters and a plurality of said resolvers are participating in said internet system in a comprehensive approach to minimize said risk.

3. The method of claim 1, wherein the internet system provides a means to connect requesters and resolvers.

4. The method of claim 1 wherein the compensation to the resolver is calculated by the internet system based on a proprietary rating system.

5. The method of claim 4, wherein the proprietary rating system is constructed from the input provided by the requester for the quality of advice that was provided regarding the issue.

6. The method of claim 1, wherein the compensation may be a monetary or non-monetary compensation.

7. The method of claim 6, wherein the non-monetary compensation comprises of points or credits.

8. The method of claim 1, wherein the requester portal provides a means for a requester to frame an issue for advice anonymously.

9. The method of claim 1, wherein the resolver portal provides a means for a resolver to provide advice anonymously.

10. The method of claim 1, wherein the requester portal provides for selection of one or more issue categories from an array of categories.

11. The method of claim 10, wherein the requester portal provides for a further selection of one or more issue subcategories from an array of subcategories.

12. The method of claim 11, wherein the requester portal provides for a means to include additional details of the issue

13. The method of claim 1, wherein the resolver portal provides for a means to provide a detailed response.

14. The internet system of claim 2, which is accessed by the means of a web or a mobile device compatible application.

15. The internet system of claim 14, wherein the web or mobile device compatible application is a special application designed to provide access to said internet system.

16. The internet system of claim 15, wherein the mobile device is a smart phone or a smart tablet.

17. The internet system of claim 2, which further comprises of:
a) a data repository;
b) a means to connect the requesters and the resolvers;
wherein the data repository comprises of information related to requester profile, resolver profile, resolution networks, issues, advice and other information exchanged between the requester and the resolver or included by said system for facilitating the exchange.

18. The internet system of claim 17, wherein the data repository comprises of repository of the current as well as archived issues and advice.

19. The internet system of claim 18, further comprising one or more sensors, wherein the sensor gathers data from the surroundings.

20. The internet system of claim 2, wherein the requester portal comprises of profile of the requester and profiles of resolvers participating in their resolution networks.

21. The internet system of claim 2, wherein the resolver portal comprises of profile of the resolver and profiles of requesters connected with said resolver.

22. The internet system of claim 20, wherein the requester portal further comprising of:
a) a means to re-open archived issues and advice and
b) a means to manage resolution networks and means to manage requester and resolver participation.

23. The internet system according to claim 2, wherein payment to the resolver is calculated based on a proprietary rating system.

24. The internet system according to claim 23, wherein the proprietary rating system is constructed by the input from the requesters for the quality of advice that was provided to them by the resolvers.

25. The internet system of claim 2, wherein the compensation may be a monetary or non-monetary compensation.

26. The internet system of claim 25, wherein the non-monetary compensation comprises of points or credits.
